(19) United States
(12) Patent Application Publication
(10) Pub. No.: US 2011/0106384 A1
(43) Pub. Date: May 5, 2011

(54) METHOD AND SYSTEM FOR MACHINERY CONTROL

(75) Inventors: Peter Corke, Queensland (AU); Jonathan Roberts, Queensland (AU)

(73) Assignee: Commonwealth Scientific and Industrial Research Organisation

(21) Appl. No.: 12/999,166

(22) PCT Filed: Jun. 16, 2009
(86) PCT No.: PCT/AU09/00763

§ 371 Date: Dec. 15, 2010

(30) Foreign Application Priority Data
Jun. 16, 2008 (AU) 2008903061

(51) Int. Cl. E02F 9/20; G06F 19/00; E02F 3/43

(52) U.S. Cl. 701/50

(57) ABSTRACT

A method for controlling an excavation device in one or more of the following phases of operation: digging, moving to spoil, dumping, recovery and return, the method including the steps of: providing a finite state machine having state variables reflecting the different phases of operation, including, digging, dumping, moving to dump location, return to dig, and bucket recover; determining current machine state depending on the position of the device; and modifying the operational behaviour of a one or more subordinate controllers in response to the current state.

### FIELD OF THE INVENTION

The present invention relates to control methods and systems for assisting operator control of machinery.

The invention has been developed primarily for use as a computer control method and system for assisting an operator's control of mining equipment during an excavation operation and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Attempts to automate draglines by a method of “replaying” previous cycles failed in the 1980's. The use of machine vision (i.e. cameras) for finding a dragline bucket was also found to be of limited practical use, due in particular to illumination issues and environmental effects such as dust and rain.

In a tight labour market, and as the pool of operator's age, it is becoming increasingly difficult to find suitable operators. Further, the effect of improved training methods has seen a plateau in operational efficiency.

There is a perceived need in that art for improved productivity, and remote operation of excavation machinery, that is less dependant on the skill variability: across a pool of operators, and skill variability of individual across shifts.

### SUMMARY OF THE INVENTION

It is an object of the invention in its preferred form to provide a control method and system for assisting operator control of machinery.

In accordance with a first aspect of the invention there is provided a method for controlling an excavation device in one or more of the following phases of operation: digging, moving to spoil, dumping, recovery and return.

Preferably, the excavation device is a dragline or electric shovel.

The method preferably comprises the steps of:
(a) providing a finite state machine having state variables reflect the different phases of operation, including, digging, dumping, moving to dump location, return to dig, bucket recover;
(b) determining current machine state;
(c) modifying the operational behaviour of a one or more subordinate controllers in response to the current state.

Determining a current machine state preferably includes determining a dynamic and kinematic state of the device, wherein the dynamic and kinematic state are obtained from other electronic systems on the device.

Preferably the method further comprises the step of obtaining additional sensor measures for tracking dragline ropes. More preferably, the method further comprises the step of: obtaining additional sensor measures; wherein the measures are used to infer one or more of the set comprising:
(i) the side-to-side angle of the hoist ropes; and
(ii) the angle of the hoist ropes from vertical within the boom plane; and
(iii) the total force acting on the suspended load;
(iv) the hoist rope force;
(v) the drag rope force;
(vi) bucket carry angle;

Preferably the method further comprises the step of: obtaining additional measures from a kinematic and dynamic model of the dragline, its drive system and the rigging system. More preferably, the method further comprises the step of: controlling the drag, hoist and slew drives by incorporating a feed-forward component from one or more of set comprising:
(i) the planned path velocity;
(ii) the planned acceleration;
(iii) the disturbance force due to the interaction forces of the hoist and drag ropes;
(iv) the disturbance force due to the weight of the bucket; and
(v) the disturbance force due to the tub slope, and bucket carry angle.

The operation of the subordinate controller is preferably modified to provide one or more operation selected from the set comprising:
(i) recovering the bucket;
(ii) disengaging the bucket from the ground at the end of bucket filling;
(iii) managing the hoist rope during digging;
(iv) maintaining carry angle during the path to dump;
(v) maintaining drag rope force within a designated bound;
(vi) maintaining swing angle within designated bounds;
(vii) controlling the bucket swing angle to direct the spoil to the desired location;
(viii) identifying the completion of bucket dumping;
(ix) placing the bucket on the ground prior to digging;
(x) dynamically varying the motor field current during operation of the device; and
(xi) eliminating stall.

The active controls are preferably used for modifying the operational behaviour of one or more subordinate controllers in response to the current state.

The method preferably comprises the step of obtaining a digital terrain map for evaluating the landscape environment about the operational location of the dragline. The method preferably comprises the step of planning a control path though space for an element of the excavation device. The method preferably comprises the step of providing a command signal indicative of moving the element of the excavation device substantially along the control path. The element of the excavation device is preferably an excavation bucket, and wherein the control path is defined in terms of an initial pose, final pose and zero or more intermediate via points.

In accordance with a second aspect of the invention there is provided a computer-readable carrier medium carrying a set of instructions that when executed by one or more processors cause the one or more processors to carry out a method as previously described.

In accordance with a third aspect of the invention there is provided a system comprising one or more processors, the processors adapted to perform a method as previously described.

In accordance with a fourth aspect of the invention there is provided a system for controlling an excavation device in one or more of the following phases of operation: digging, moving to spoil, dumping, recovery and return.

The excavation device is preferably a dragline or electric shovel.

The system preferably comprises a sensor for tracking dragline ropes.

The device is preferably controlled to provide one or more operation selected from the set comprising:
(i) recovering the bucket;
(ii) disengaging the bucket from the ground at the end of bucket filling;
(iii) managing the hoist rope during digging;
(iv) maintaining carry angle during the path to dump;
(v) maintaining drag rope force within a designated bound;
(vi) maintaining swing angle within designated bounds;
(vii) controlling the bucket swing angle to direct the spoil to the desired location;
(viii) identifying the completion of bucket dumping;
(ix) placing the bucket on the ground prior to digging;
(x) dynamically varying the motor field current during operation of the device; and
(xi) eliminating stall.

The dragline controls are preferably active controls. The active controls are preferably implemented using electric motors through an electric clutch, such that when the dragline is controlled the manual control inputs are engaged. The active controls preferably interpret restriction in their motion as an override request, which deactivates the automatic control of the dragline and reverts back to manual control.

Preferably training is manually provided. Training preferably includes identifying the location of the dig point and the location of the dump point. Training preferably further includes identifying the location of intermediate via points.

The system is preferably adapted to obtain a digital terrain map for evaluating the landscape environment about the operational location of the device.

### BRIEF DESCRIPTION OF THE DRAWINGS

A preferred embodiment of the invention will now be described, by way of example only, with reference to the accompanying drawings in which:

FIG. 1A is an example front view of a dragline;

FIG. 1B is a side view of the dragline of FIG. 1A;

FIG. 2A is an example flowchart of a method according to the invention;

FIG. 2B is an example flowchart of a method according to the invention;

FIG. 3A is an example schematic view of a control system according to the invention;

FIG. 3B is an example schematic view of a control system according to the invention;

FIG. 4 is a perspective view of an operator's monitor;

FIG. 5 is a side view of a dragline showing a hoist rope tracker boom platform;

FIG. 6A to FIG. 6D is side views of a dig site, illustrating a number of dig and dump configurations;

FIG. 7 is an example perspective view of active dragline controls;

FIG. 8 is a histogram of swing angles for assisted and manual cycles;

FIG. 9 is sample cycle time histograms for binned swing angles range 86°-95°;

FIG. 10 is sample cycle time histograms for binned swing angles range 136°-145°;

FIG. 11 is sample cycle time histograms for binned swing angles range 186°-195°;

FIG. 12 is a histogram comparing the mean cycle times for operator control and DSA control over identified binned swing angles;

FIG. 13 is a histogram comparing the peak cycle times for operator control and DSA control over identified binned swing angles;

FIG. 14 is a histogram of the percentage of DSA cycles that are completed quicker (or as quick) as the mean manual cycle time for each swing angles;

FIG. 15 is a histogram comparing two-point DSA swing angles to all DSA cycles and manual cycles.

FIG. 16 is a histogram (similar to FIG. 12), comparing the mean two-point cycle times for binned swing angles;

FIG. 17 is a histogram (similar to FIG. 13), comparing the peak (mode) two-point statistics for binned swing angles;

FIG. 18 is a histogram of percentage of two-point DSA cycles better than mean manual operator cycle times;

FIG. 19 is a scatter plot of the distribution of cycle times with swing angles for adjacent manual/assist cycles;

FIG. 20 is a histogram of the binned swing angles for adjacent manual/assist cycles;

FIG. 21 is a histogram (similar to FIG. 12), comparing the mean cycle times of binned swing angles for adjacent manual/assist cycles; and

FIG. 22 is a histogram (similar to FIG. 13), comparing the mean cycle times of binned swing angles for adjacent manual/assist cycles.

### PREFERRED EMBODIMENT OF THE INVENTION

In an embodiment, automation is used to improve efficiency and productivity in the open-cut mining domain, and more specifically, the automation of a dragline's cycle of work. It will be appreciated that this automation can assist an operator in a phase of the operating cycle, or take over from the operator during a phase of the operating cycle. This automation can also be used to raise productivity and/or assist in enabling remote operation of draglines. It will be further appreciated that this automation has applicability to other machinery, in particular excavation machinery.

It will be appreciated that automating operation of excavation machinery can reduce the risk of damage to machinery, thereby improving the “uptime” and lifespan of a machine. It will be further appreciated that reduce the risk of damage to machinery can further assist in improving productivity.

A dragline is a rotating machine that moves its bucket using two ropes (drag and hoist). A universal dig and dump dragline is a rotating machine that moves its bucket using three ropes (drag, front hoist and rear hoist). A rope shovel is a rotating machine that moves its bucket using two ropes (crowd and hoist) and includes a rigid structural element (paddle). Whilst the preferred embodiments refer to a dragline environment, it will be readily evident to those skilled in the art that they are directly applicable to other heavy machinery.

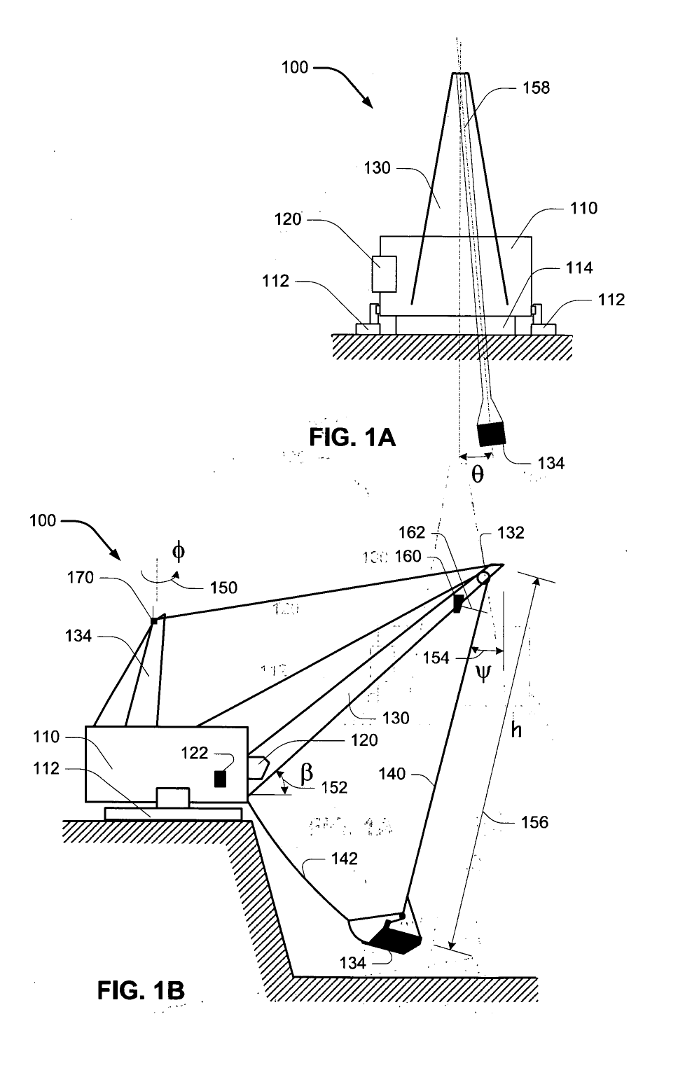

FIG. 1A and FIG. 1B respectively show an example front and side view of a dragline 100. The dragline comprises a main housing (or house) 110, which is movable though actuation of walking shoes 112, and rests on a base (or tub) 114 during excavation. An operator can be positioning in a cab 120 for controlling the dragline. It will be appreciated that the operator can be remote from the dragline. An automaton computer 122 also assists control of the dragline.

A boom 130, boom sheaves 132 and mast 134 are provided for supporting and facilitating manipulation and operation of a bucket 134. This bucket is manipulated during excavation, in part, by a hoist rope 140 and drag rope 142. Further controlling and monitoring of slew rotation 152, boom angle 152, hoist rope angle 154, hoist rope length 156, and hoist rope plane. A hoist rope measurement device in the form of a laser scanner 160 can, for example, identify the location of the hoist rope in scanning plane 162.

Remote communication and/or monitoring can be achieved over a radio link using a radio device 170.

An embodiment contributes to an improved operational efficiency of a dragline. This improved operational efficiency can include a decrease in average swing time—that is between digging and dumping—and a decrease in the wear and tear on the dragline structure, drive systems and associated machinery. It will be appreciated that human operators do not perform optimally over a work shift and can easily inflict damage on the dragline due to incorrect operation, and this improved efficiency can improve productivity and reduce maintenance costs.

In an embodiment, there is provided a method for controlling the operation of excavation device, such as a dragline, in some or all phases of its operating cycle: digging, moving to spoil, dumping, recovery and return. It will be appreciated that this method can be further used for measurement and generation of productivity statistics. It will be appreciated that the operator can be remote from the dragline.

### Finite State Machine

The method includes using a finite state machine (FSM) whose formal state variables reflect the different phases of operation. These phases of operation including, but not limited to, digging, dumping, moving to dump location, return to dig, bucket recovery etc.

In an embodiment, by way of example, state transitions can be based on events determined from measured variables and or time intervals and or a human operator input.

Controller sequencing using a controller state machine including states:
TIGHTEN, DISENGAGE, TODUMP, DUMPING, RECOVER1, RECOVER2, TODIG, APPROACH, IDLE.

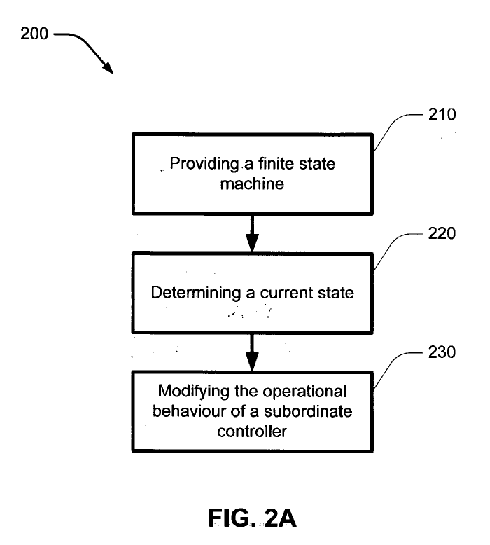

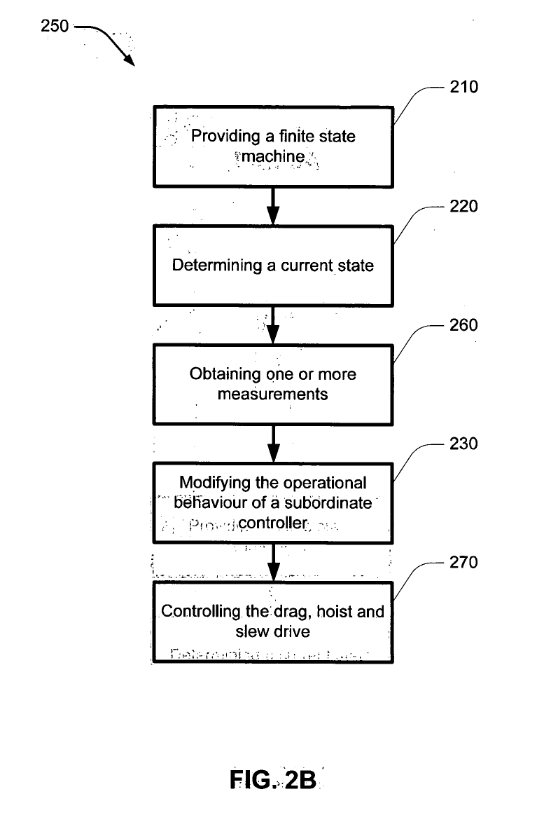

Referring to FIG. 2A and FIG. 2B, each shows an example flowchart of implementing method of automation, 200 and 250 respectively. As shown in FIG. 2A and FIG. 2B, these methods can include the steps of:
1. Providing a finite state machine (FSM) 210;
2. Determining the current machine state 220;
3. Obtaining one or more measurements 260;
4. Modifying the operational behaviour of a subordinate controller 230; and
5. Controlling the drag, hoist and slew drive 270.

### Motion Planning

In an embodiment, a motion planner can provide a method of continuous (smooth) commanded values for rope lengths and house rotation angle. This method can control the motion of the bucket through space as defined in terms of an initial pose, final pose and by zero or more intermediate (“via”) points. This method can be based on coordinated single-axis planners for each rope and house slew angle. The motion can comprise constant velocity segments joined by smooth functions (polynomial, trigonometric or other). The duration of the smooth joining functions can be based on: the velocity change and known drive limits; or the worst-case velocity transition time for all drives. The motion planner can further include input of load weight and tub tilt.

In an embodiment, by way of example only, a motion planner provides continuous (smooth) command values for rope lengths and house rotation angle. A “flexible motion” planner can be used to generate independent motion of each drive, subject to predefined constraints associated with velocity and higher order temporal derivatives. Further information on Model-based control of hydraulically actuated manipulators is disclosed by M. Honegger and P. Corke “Model-based control of hydraulically actuated manipulators” (Proceedings IEEE Int. Conf. Robotics and Automation, pages 2553-2559, Seoul, May 2001). The contents of the aforementioned disclosure are incorporated herewith by cross-reference.

In an embodiment, an estimated completion time of each axis can be computed and the motion parameters of the drives adjusted so that completion times of all drives are coordinated. Motion segment parameters can be further based on the identified machine load. The motion planner can further include input of load weight and tub tilt.

The tracking performance of the drives can be monitored from which motion segment parameters are adjusted so that all drives are tracking within designated bounds. Alternatively, the tracking performance of the drives is monitored from which motion segment parameters are adjusted so that one drive is always operating at the limits of its performance.

The method can further calculate a minimum time path. A dynamic programming technique can be used in implementing the method of modelling achievable motor speed as a function of dragline rope configuration based on known torque-speed characteristics of the motor drives. Such planning can be conducted in a non-Cartesian coordinate space. For example, the coordinates can include drag rope length and hoist rope length.

The method can further consider bucket obstacles such as the boom, cable, auxiliary equipment, plant, vehicles and terrain that can be transformed into the coordinate space and used for planning.

The method can further calculate a minimum time path by considering continuous rotation of the dragline. For example an empty bucket may swing over the power cable, but not a full bucket.

### Sensing and Terrain Mapping

Preferably the dynamic and kinematic state of the device is sensed (using one or more sensors) and used for control purposes. It would be appreciated that plurality of sensors (or alternatively scanning means) can be used for control purposes. These sensors can include, but are not limited to, accelerometers, gyroscopes or magnetometers and GPS.

It would be appreciated the bucket position sensing can be employed.

A sensor can measure (or infer) the side-to-side angle of the hoist ropes, referred to as swing angle. The swing angle can be inferred using one or more ranging sensors that emits electromagnetic or acoustic energy and detects its return. Signal processing can include range gating, adjacent target merging, rope discrimination, tracking and data association. Alternatively, the swing angle can be inferred using image-processing techniques from one or more cameras that are position to observe the hoist ropes.

A sensor can measures (or infer) the angle of the hoist ropes from vertical within the boom plane, referred to as hoist angle. The hoist angle is inferred using one or more ranging sensors that emits electromagnetic or acoustic energy and detects its return. Signal processing can include range gating, adjacent target merging, rope discrimination, tracking and data association. Alternatively, the hoist angle can be inferred using image processing techniques from one or more cameras that observes the hoist ropes.

In an embodiment, the dynamic and kinematic state of the dragline is obtained via an electronic or communications bus from other systems on the dragline, including but not limited to, a performance monitor or motor drive systems. This can include, but is not limited, to motor angular position, motor speed, motor torque, motor armature voltage and current, motor field current etc.

In an embodiment, the dynamic and kinematic state of a dragline is estimated or inferred from measured variables and a kinematic and dynamic model of the dragline—including its drive system and the rigging system.

The total force acting on the suspended load can also be measured (or inferred). The total force acting on the bucket can be inferred from measurements of hoist rope force and drag rope force as well as one or more of a kinematic model of the rigging geometry, knowledge of hoist rope angle, knowledge of swing angle, drag and hoist rope lengths, dynamic model of the suspended load.

The hoist rope force can be inferred from:
(a) measured strain in the boom structure; or
(b) measured total deflection of the boom structure; or
(c) reaction forces measured in the hoist sheave bearings; or
(d) or measured motor current, measured or known field current and a model of the motor torque function.
(e) Motor or gearbox shaft strain

The drag rope force can be inferred from:
(a) measured strain in the boom structure; or
(b) measured total deflection of the boom structure; or
(c) reaction forces measured in the hoist sheave bearings; or
(d) or measured motor current, measured or known field current and a model of the motor torque function.
(e) Motor or gearbox shaft strain

The friction forces experienced by the drag and hoist ropes running over sheaves from their winch drums to bucket are typically known.

The friction forces are typically characterised by means of experiment for various known values of rope speed and motor torque and bucket weight. The friction forces can be estimated continuously online by means of a friction model and estimates of rope speed and motor torque.

The friction model comprises one or more of a symmetric Coulomb friction component, an asymmetric Coulomb friction component, a symmetric viscous friction component, and an asymmetric viscous friction component.

The friction can be further parameterized by payed out rope length of either (or both) drag or hoist. The friction can be further inferred by the instantaneous value of a state finite machine.

The hoist rope force vector can be inferred from the hoist rope angle and the swing angle and the hoist rope force magnitude. Alternatively, the drag rope force vector can be inferred from the hoist rope angle and the swing angle and the drag rope force magnitude.

The total force applied to the bucket by the dragline is the vectorial sum of the rope forces acting on the bucket. The mass of the suspended load can be determined from the estimated force by subtracting the inertial forces due to the acceleration, Coriolis and centripetal effects.

Alternatively a dynamic model of the dragline and the suspended bucket and the machine state can be used to estimate bucket weight and swing angle.

Alternatively the bucket weight is inferred from the additional rotational inertia of the dragline's slew drive. Alternatively, the bucket weight is inferred from the estimated disturbance torque acting on the dragline's slew drive. The fusion of these various bucket weight estimates can be used to create a more accurate (or robust) measure.

The estimation of bucket carry angle can be inferred from rigging geometry, rigging parameters and a kinematically-constrained dynamical model.

A digital terrain map may be created from a boom mounted laser scanner. The system can be calibrated (using targets and an optimisation procedure) to determine the critical distances and angles within the system (for example, distances between the GPS receiver and the laser etc.).

### Motor Control

In an embodiment, by way of example only, a method for controlling the drag, hoist and slew drives includes a feed-forward component from one or more of (but not limited to) the planned path velocity, the planned acceleration, the disturbance force due to the interaction forces of the hoist and drag ropes, the disturbance force due to the weight of the bucket, the disturbance force due to the tub slope, and bucket carry angle.

This is further disclosed in the following aspects:
(a) Control on drag and hoist rope lengths, including using a proportional controller plus velocity feed-forward term; and using direction dependent gains; and conditioning by position and rate limits.
(b) Control on house slew using a proportional plus velocity feed-forward term; and conditioning by position and rate limits.
(c) Control on rope tension, including maintaining drag motor current; and reducing drag motor current; and improving tracking error on hoist
(d) Control on bucket swing, including operating during dumping or bucket placement; and adding to the control on house slew; and damping them with a lead compensator
(e) Bucket recovery, including using indirect cues to trigger a timer which puts drag controls into neutral for a programmable period—such as divergence of laser measured rope angles and geometric calculation of rope angles

### Subordinate Controllers

The method includes enabling and/or disabling and/or otherwise modifying the behaviour of one or more subordinate controllers for specific purposes of completing a phase of operation. For example, a subordinate controller can be used for automated bucket recovery. A system may include a plurality of subordinate controllers to perform a respective plurality of operations. It would be appreciated that each subordinate controller can be implemented, at least in part, by software—and may thereby be embodied in a single computer system.

A subordinate controller can be used for managing the hoist rope during digging operations. This controller can embody a method that uses a measured hoist rope force and a control loop to maintain hoist rope tension within designated bounds. Alternatively, this controller can embody a method that uses a measured hoist rope angle and a control loop to maintain this within designated bounds based on known drag rope length. This controller can embody a method that uses the known 3D profile of the bank in which digging occurs.

A subordinate controller can be used to substantially eliminate stall by monitoring the drag rope force and/or drag motor load during digging. A setpoint can be reduced if a designated threshold is exceeded.

The method can detect the end of bucket filling. The end of filling can be identified by any one or more of the following:
(a) the press of a button
(b) movement of the drag and hoist joysticks
(c) observed force on the drag rope.
(d) a 3D sensing means that determines the amount of material within the bucket or pushed up in front of the bucket.

A subordinate controller can be used for automatically disengaging the bucket from the ground at the end of bucket filling. A control loop increases the hoist rope force until a designated threshold is exceeded after which time the hoist rope becomes length controlled.

A subordinate controller can be used to maintain carry angle during the path to dump a load. This controller can embody a method that uses a bucket carry angle measure or estimate to maintain appropriate drag rope length. This controller can embody a method that maintains drag rope force per 17 within designated bounds.

A subordinate controller can be used to control drag rope force within a designated bound during the path to dump in order to minimize “tight line” effects which increase hoist rope tension and lower hoisting speed.

A subordinate controller can be used to control the bucket swing angle so as to spoil at the desired location while maintaining swing angle within designated bounds. This controller can embody a method in which the bucket swing angle control includes feedback of bucket swing angle, and optionally its higher order temporal derivatives. This controller can embody a method in which the control gains are not constant but computed as a function of measured drag and hoist rope lengths in order to achieve a desired damping ratio. This controller can embody a method that uses a dynamic model of the suspended load and the commanded acceleration profile of the house motion and the desired spoiling location. This controller can embody a method in which bucket swing angle is controlled so as to reach the spoiling location while the house is returning to the dig location. An optimal controller or receding horizon control system can be used to plan the house motion profile in order to achieve the desired coordinated motion of house and bucket, and where the bucket's swing angle during dumping is a parameter of the motion.

In an embodiment, the method includes monitoring the swing angle during manual operation and modifying the operator commanded house rotation in order to maintain the bucket swing angle within designated bounds.

It would be appreciated that spoiling location can be specified as a spatial region or a point. The spoiling point can be moved within the spoiling region to effect appropriate material distribution. The identification of a spoiling point can be further based on knowledge of a digital terrain map for the spoiling region. The identification of a spoiling point can also take into account a model of material flow over the digital terrain map. A desired spoiling location can be:
(a) determined by the operator.
(b) determined from a digital terrain map of the environment.
(c) provided in absolute coordinates.

It will be appreciated that the spoiling height can be adjusted based on time, number of dumps at each location, online from digital terrain map or from a material flow model. The desired spoiling location can be a hopper or truck. The position of the hopper or truck can be marked by the operator. Alternatively, the position of the hopper or truck is known to the dragline control system by means of its transmitted location and orientation derived from, but not limited to, GPS location of points, compass bearing of axis of the hopper or truck. The hopper or truck can be determined online from one or more 3D sensors mounted on one or more of the dragline, the truck or hopper or the some other structure or vehicle in the vicinity. The spoiling location can be given in absolute or dragline relative coordinates.

A subordinate controller can be used to determine the completion of bucket dumping. This controller can embody a method in which the dumping completion is based upon any one or more of: time; weight; a change in measured hoist motor current; bucket hoist angle exceeding a designated bound; bucket carry angle.

A subordinate controller can be used for automated bucket recovery. This controller can embody a method that takes into account the difference between the hoist rope angle computed from drag and hoist rope lengths, and that measured directly. This controller can embody a method that takes into account the temporal derivatives (first order, second order and so on) of the difference between the hoist rope angle computed from drag and hoist rope lengths, and that measured directly. This controller can embody a subsidiary finite state machine, in which the state transitions are triggered by changes in these measured signals and time intervals.

A subordinate controller can be used to place the bucket on the ground prior to digging. This controller can embody a method in which the target location is any one or more of the following: marked by the operator; a function of the previous disengage point; automatically selected within a specified digging region; determined from a digital terrain map. The bucket landing on the ground can be identified by a change in the apparent (measured) bucket weight.

A subordinate controller can be used to dynamically vary the motor field current. This controller can embody a method in which the motor field current is varied dynamically during the motion. Alternatively, this controller can embody a method in which the motor field current is controlled dynamically in order to achieve time optimal motion of the bucket.

### Operator Interface

An operator interface may use active controls, (including but not limited to joysticks and foot pedals) which include the addition of servo-motors to the operators controls. The active controls can be used to indicate to the operator the current drive state of the machine. The active controls may also be used to provide tactile signals to the operator, indicating limits to performance such as overloaded buckets or machine stall. These active controls are used in turn control a dragline. This facilitates smooth transfer of operation between the control system and the operator. The use of active joysticks can provide a smooth and safe transfer of control between an operator and an automation system.

In an embodiment, the active control maybe integrated with an existing dragline control device whose physical motion commands the motor drive system. In this case the active control moves the control input directly which provides the advantages listed above while also respecting all the existing interlocks (tight-line limits etc).

Alternatively, a control input can be provided to the dragline via a separate path and an input element (e.g. joystick) is moved to mirror that input control, but in this example the input element does not provide the control input for the device.

It will be appreciated that, example active controls can serve at least two purposes:
(a) providing commands to the machine; and
(b) providing information and/or feedback to an operator.

In an embodiment of the present invention, it is possible to further automate the operation of a dragline, thereby elevating the human operator to a more supervisory role and/or task planner. It would be appreciated that it is possible for a computer to emulate all of the essential operator skills: disengaging from the bank, dumping and bucket recovery.

In an embodiment, swing assistance can be applied to mining excavation equipment (for example draglines such as the BE1350 dragline). This dragline swing assistance (DSA) provides novel dragline operation and can be applied as an addition to any other dragline technology (for example parallel rigging, or universal dig & dump).

It will be appreciated that the best path for the bucket to travel is a function of machine limits, the terrain and the particular dig and dump point. For machine safety, it is possible to select conservative bucket paths to avoid bucket/spoil collisions. This resultant over-hoisting imposes a time penalty. Without terrain information the method and system preferably does not skim the bucket close to the spoil pile, unlike a skilled operator, which can lead to performance differences. The integration of terrain mapping with the dragline swing assist technology can allow safe and optimum terrain skimming bucket motion between dig and spoil point. Further, by way of example only, an integrated terrain mapping and swing assist system can be integrated with other dragline productivity improvements—such as the parallel rig or universal dig and dump.

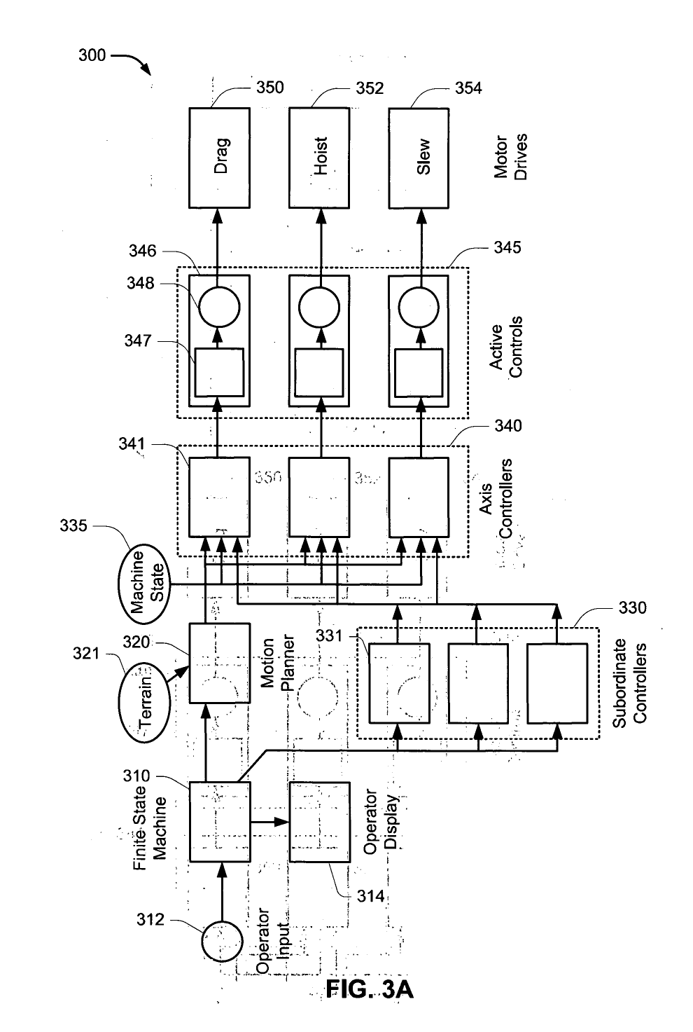

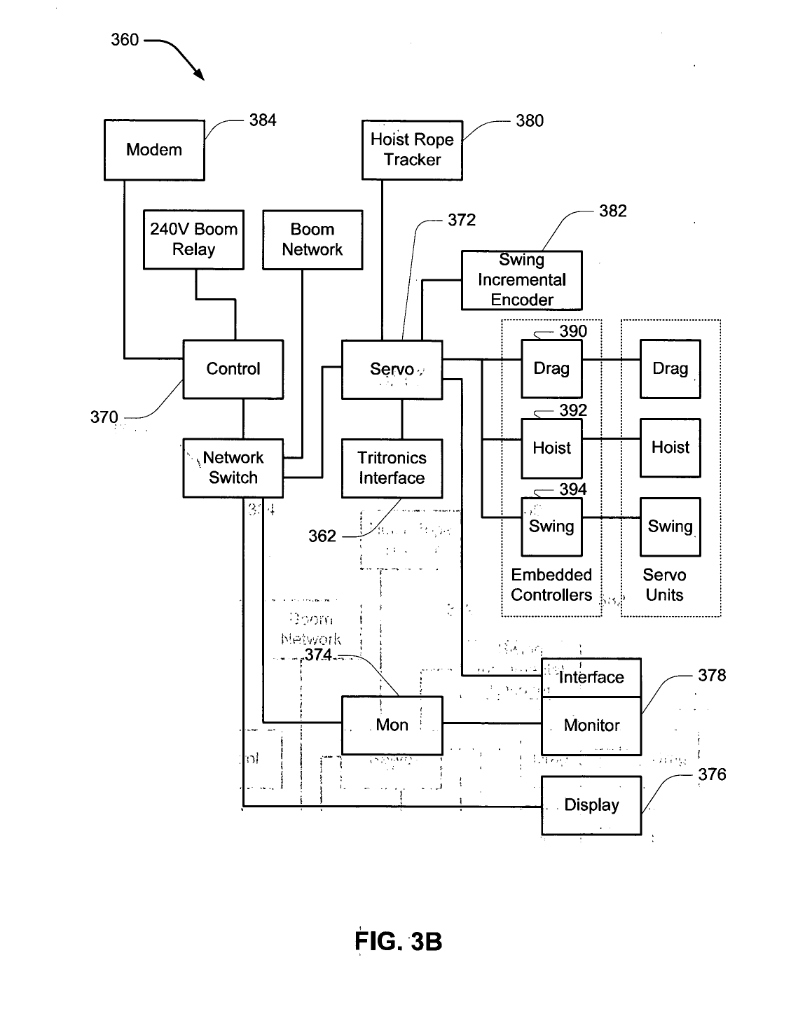

FIG. 3A shows an example schematic view of a control system 300. In this example, a Finite State Machine (FSM) 310 receives input from an operator 312. The FSM provides output to an operator display 314, a Motion Planner 320 and a plurality of Subordinate Controllers 330 (in the form of three Subordinate Controllers 331). The motion planner can receive terrain information 321.

A plurality of Axis Controllers 340 (in the form of three Axis controllers 341) receive input data in the form of the current machine state, and data output by the Motion Planner and respective Subordinate Controllers. The Axis Controllers 340 further controls respective Active Control from a plurality of Active Control 345. In this example three active controls 346 each include a servo-motor 247 and operator input element 348 (e.g. a joystick). The active controls are adapted to control a respective motor drives—in this example, a Drag Motor Drive 350, a Hoist Motor Drive 352, and a Slew Motor Drive 354.

FIG. 3B shows an example schematic overview of a DSA control system 360 installed on a dragline, in this example a BE1350 dragline. In this example sensor signals from the Tritronics system 362 are available, which reduces the installation complexity and increased reliability. Further, a master switches was used instead of joystick controls. This system contains four networked computers—control 370, servo 372, mon 374 and display 376.

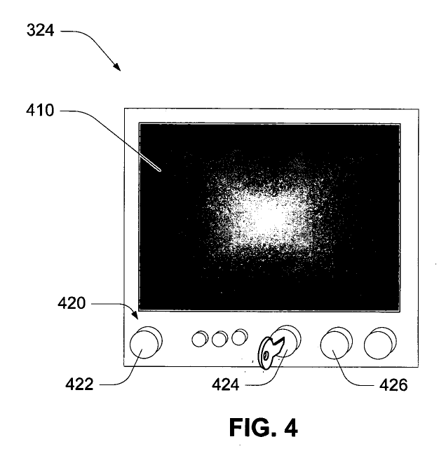

As best shown in FIG. 4, the mon computer 374 includes monitor 410, which is preferably mounted beside the operator, provides an operator access to control buttons/indicators 420.

These operator control buttons/indicators 420 provide the following functions:
ESTOP 422—removes power from any active controls so they cannot be moved by the DSA system. In this example, pressing ESTOP does stop the dragline, it restricts DSA system control.
DSA enable 424—a key switch enables the DSA system to be operational.
Active control 426—a blue status light indicates that the active controls are powered, and that DSA system is capable of driving the dragline.

Control 370 and servo 372 can be mounted in cabinets located in the dragline lower electrical control room. Servo 372 is a computer system adapted to execute a DSA system program. As best shown in FIG. 3, servo 372 acquires data from the hoist rope tracker 380, swing incremental encoder 382 and Tritronics interface 310 and controls the dragline via the drag 390, hoist 392 and swing 394 embedded controllers. Control 370 is a compile computer for allowing offline development and testing of DSA system code and supports a connection to a modem 384 for external communications.

In this example, the display 376 is mounted as a heads-up display for the operator, preferably on top of the existing Tritronics monitor operator interface 378.

Display 376 may be further coupled to a touch screen for provides the operator with DSA system status information and adjustment controls via different screens. By way of example, the background colour of the display can indicate a primary status of the DSA system, such as
Black—DSA system off line
Green—untrained.
Blue—being trained.
Red—DSA active.

By way of example only, a interface to the draglines sensors is provided via an embedded controller that shares the electrical inputs of a dragline monitor, such as the Tritronics 9000 Series 3 Dragline Monitor, and transmits data to servo 372 via an isolated serial link. The unit is preferably mounted on the inside of the cabinet door housing the monitor.

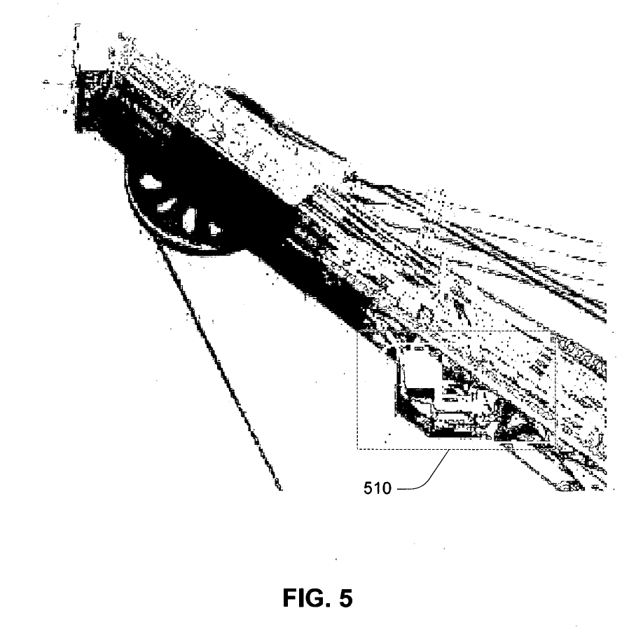

By way of example only, the hoist rope tracker system 380 can be mounted on a special platform just below the dragline's boom tip 510, as best shown in FIG. 5.

The operation of the DSA system operates in conjunction with the operator, such that sometimes the operator is providing control, at other times the DSA computer is providing control. This control is passed between the operator and DSA computer as appropriate. Typically the dragline operator will load the bucket and handover control to the DSA system. The DSA system will then disengage, hoist, swing, dump, recover and return the bucket to the original digging point in the pit.

When the DSA system is providing control, the control inputs (sticks and pedals) physically move, as if they were under manual control. This mode of operation is referred to as active controls, as they are implemented by small electric motors that—when the dragline is under DSA control—engage with the control inputs through an electric clutch. These active controls interpret restriction in their motion as an operator override (takeback) request, which deactivates the DSA system and reverts control of the dragline to the operator. In this example, the operator is the master of the dragline and ultimately responsible for its operation.

If the DSA system identifies a problem, for example with any of its subsystems, it will signal the operator to announce that the DSA system has experienced a problem and has returned all control to the operator.

In an embodiment, training can be provided before the DSA system is used. This training involves the operator making the system aware of its operating environment, for example—the location of the dig point, the location of the dump point.

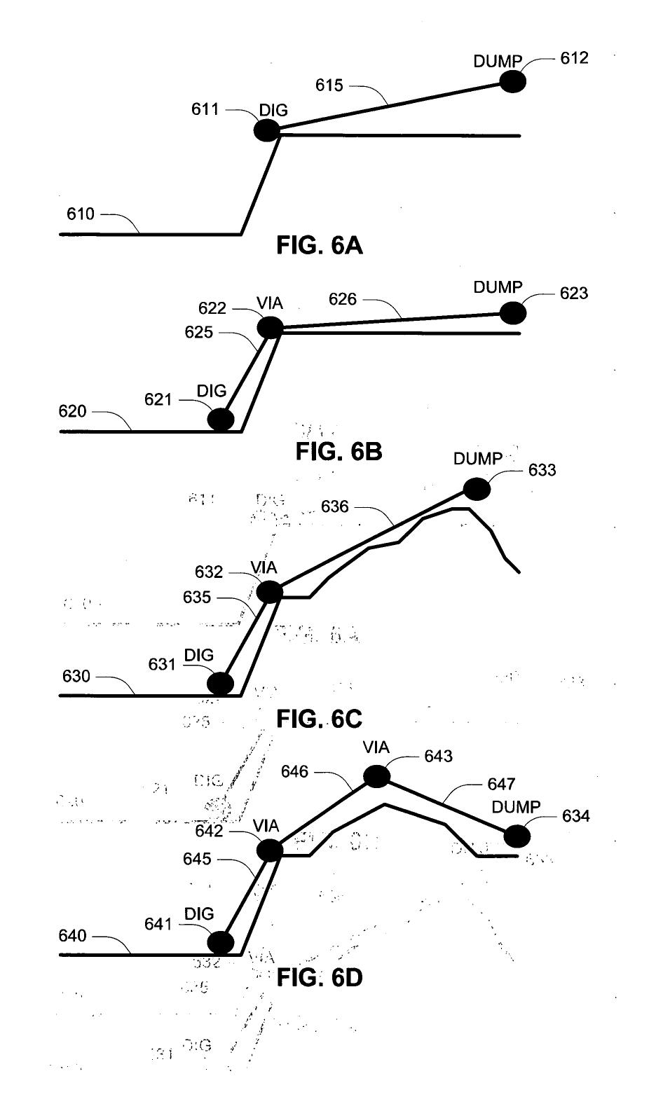

Referring to FIG. 6A, FIG. 6B, FIG. 6C, and FIG. 6D, the training can be in the form of a series of points that define a keep out region for the bucket. These show a side view of a dig site illustrating a number of dig and dump configurations. FIG. 6A shows top pulling—low spoiling. FIG. 6B shows deep digging—low spoiling. FIG. 6C shows deep digging—high spoiling. FIG. 6D shows deep digging—low spoiling over spoil pile.

FIG. 6A shows a minimum number of trained points for this example is two, a dig point 611 and a dump point 619. This defines a path 612. FIG. 6B shows three training points 621, 622 and 623 defining a path 625 through 626. Similarly, FIG. 6C shows three training points 631, 632 and 633 defining a path 635 through 636. FIG. 6D shows four training points 641, 642, 643 and 644 defining a path containing segments 645, 646 and 647.

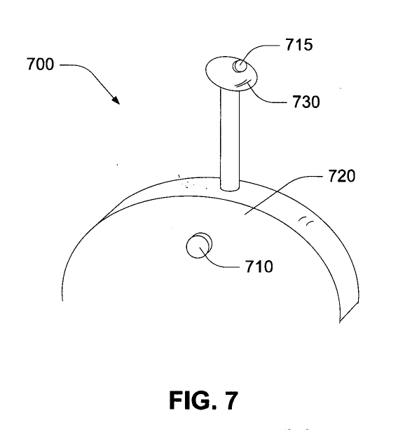

The operator can preferably perform this training during a normal manual cycle. Referring to FIG. 7, by way of example only, the dragline controls 700 provide two control buttons 710 and 715. A push on/push off training button 710 is located on the side of the drag stick cover 720. A momentary activate button 715 is located on the dragline “stick ball” 730.

The training button 710 can allow the operator to toggle the training state, for example pressing the training button selects training mode, press the training button again de-selects training mode (returning to operational mode).

The activate button 715 is used to “mark” points in space when in the training mode and instigates a DSA controlled cycle when in the operational mode.

It would be appreciated that, by way of example,
Each automatic swing calculates a path for the bucket at the handover point to the dump point, wherein a DSA system does not replay the motion of the bucket seen during training.
A DSA system may operate the dragline in a manner, which differs with operational training or experience.
A DSA system typically cannot assess the terrain around the dragline without video input. Therefore without this input the system sets very conservative bucket paths, which introduces a time penalty due to over hoisting.

### Trial Results

By way of example only, a DSA system installed on a BE1350 dragline was used as a trial situation, and is discussed further below.

The system includes the following:
Sensor and computer technology;
Control algorithms;
Operator interface

Features of this system can include:
Reliable operation;
Modular design for easy to retrofit and maintenance;
Unobtrusive; and
Operator interface is intuitive and well received by operators.

The trial provided two weeks of uniform digging conditions, which was preferred for comparing human and computer controlled cycles.

In this trial, the methodology was to operate the system for one hour followed by one hour of manual operation. This would allow a meaningful comparison with similar operating conditions. These tests ran for two shifts each day.

Key outcomes of the trial included:
Over 250,000 tonnes of overburden shifted under computer control
Operators were unable to tell whether the computer or an operator was driving based on observations from outside the cab.
On a raw average of cycle time the automation system was 6% slower than the human operator;
For some situations the computer control was comparable with the operator.
For a class of paths with no via points the automation system exceeded average operator performance in 50-70% of swings.

To somewhat void an issue associated with how the swing and return parts of the cycle are partitioned, analyses will be based on total cycle time—swing plus return time.

The trial methodology is based on dividing the cycles according to the swing angle range, grouping them into ‘bins’ that are 10 degrees wide.

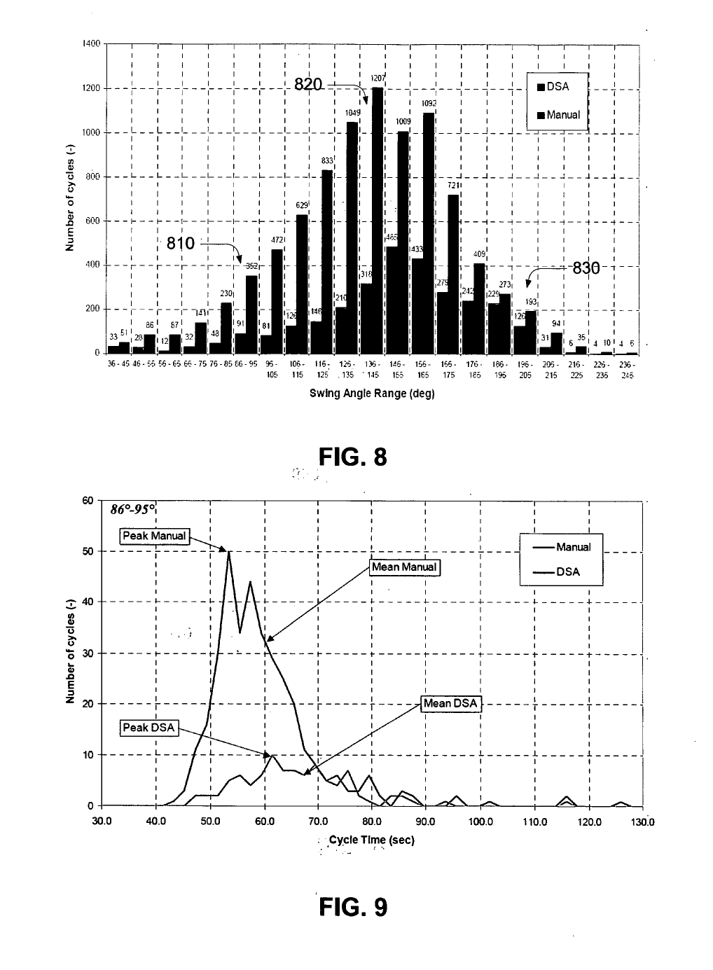

FIG. 8 shows the number of manual and computer cycles achieved over the trial. A total of 12,235 cycles were recorded during the trial: 3,042 with DSA and 9,193 manual cycles.

It will be appreciated that there is trade-off between the bin size. Narrow bins will have too few, or zero, cycles to be useful. Wide bins will have a large distribution of cycle times due to the maximum swing rate. For example, a 10 deg bin will have a spread of at least 1.5 s if the maximum swing rate is 6 deg/s.

It would further be appreciated that the cycles are binned purely on the basis of the swing angle, and may have occurred at widely separated times during the trial. This may also correspond to widely different digging conditions.

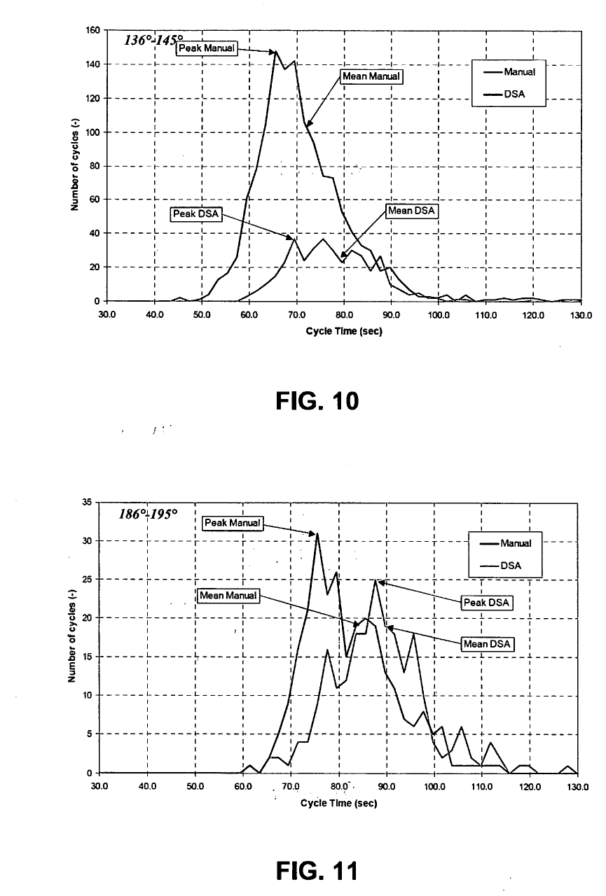

Referring initially to FIG. 8, some representative bins—86°-95° (810), 136°-145° (820) and 186°-195° (830), FIG. 9 shows histograms of the cycle time associated with 86°-95°, FIG. 10 shows histograms of the cycle time associated with 136°-145°, and FIG. 11 shows histograms of the cycle time associated with 186°-195°. These figures show the distribution of cycle times whose swing angle falls within the binned range, for both the manual and DSA cycles as recorded by the Tritronics system. Also indicated by the arrow tips are the calculated mean and peak cycle times for the binned data.

FIG. 9, FIG. 10, and FIG. 11 show, for a particular swing angle, there is a best possible time (due to motor performance limits). However, it was observed in practice that, both the operator and the DSA system have some considerable scatter in the achieved cycle times. For the manual cycles this may reflect different operators, normal operator variability or different digging conditions (perhaps hoist limited). For the DSA system a notice scatter was observed, in particular a ‘long tail’ on the distribution.

This ‘long tail’ can reflect the ‘tune in’ process including each time the DSA system is started there is a need to adjust some parameters in order to optimise cycle time and finesse the dump and recovery performance.

It is beneficial to express performance within the bin using some compact statistic.

Such a statistic is to compute the percentage of DSA cycles that are completed in the same or less time than the mean manual time. This statistic does not involve estimating the peak of a distribution—which is a difficult task for a small number of samples where the distribution is far from normal.

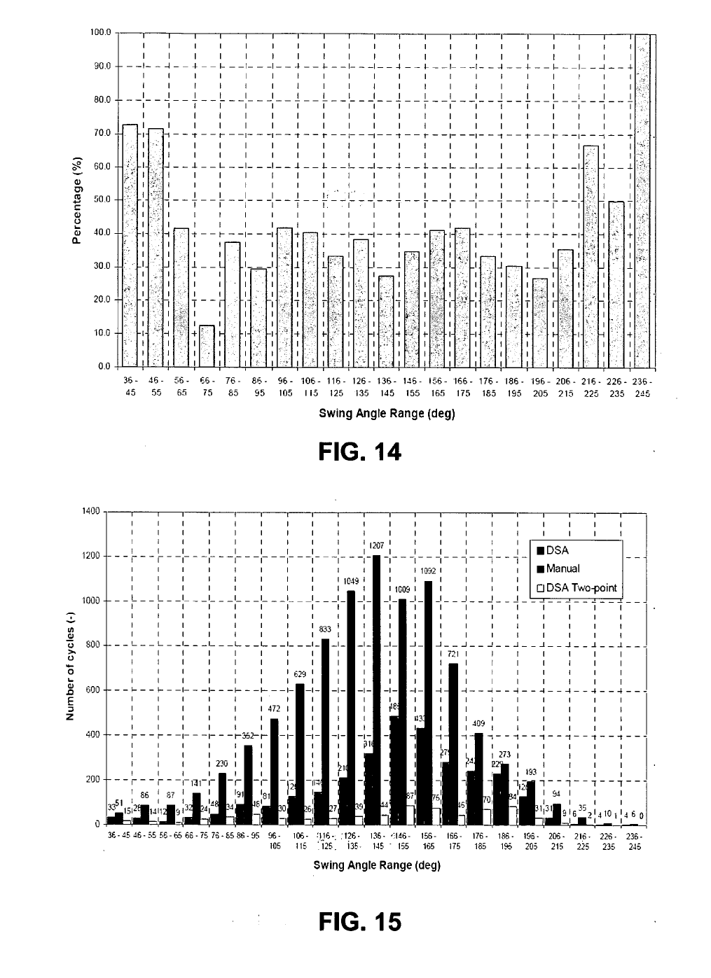

FIG. 14 shows the calculated percentage of DSA cycles that are completed quicker (or as quick) as the mean manual cycle time for each swing angles. This histogram shows, in general, that the DSA has statistically slower cycle times. However, it also indicates that 30-40% of all DSA cycles are better than the manual mean cycle time. It can also be observed that, for the small and long swing angles—50-70% of DSA cycles are better than the mean manual cycle times.

To better assess this behaviour we selected only those DSA cycle which corresponded to two-point cycles, as best shown in FIG. 6A. In this situation only 637 out of 3042 cycles (or 21%) fall into this category. FIG. 15 shows the distribution of two-point DSA cycle swing angles compared to all DSA and manual cycles.

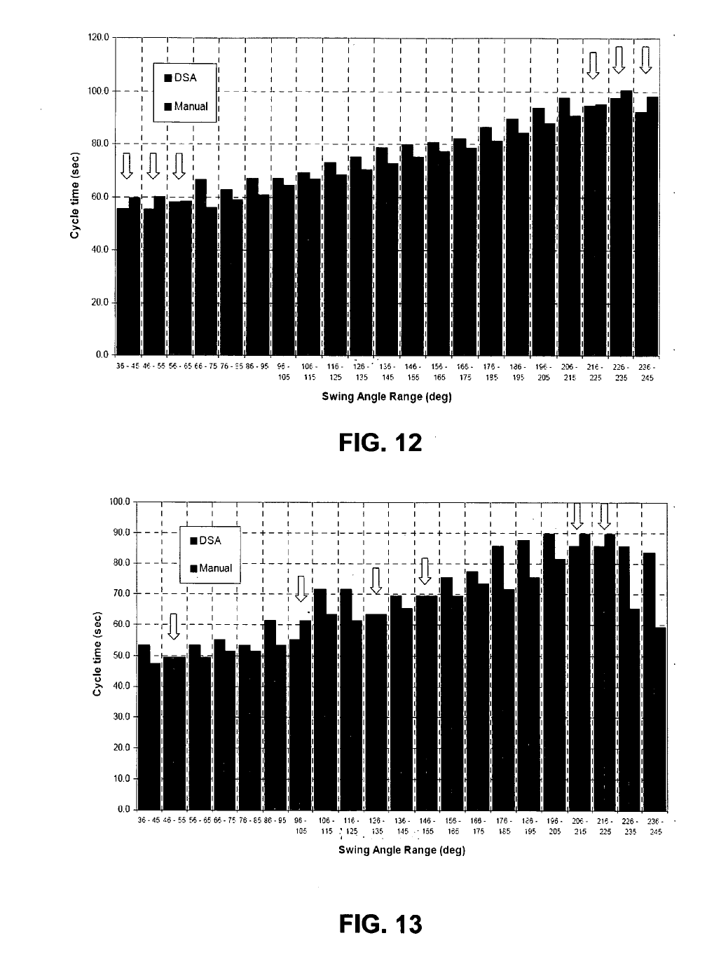

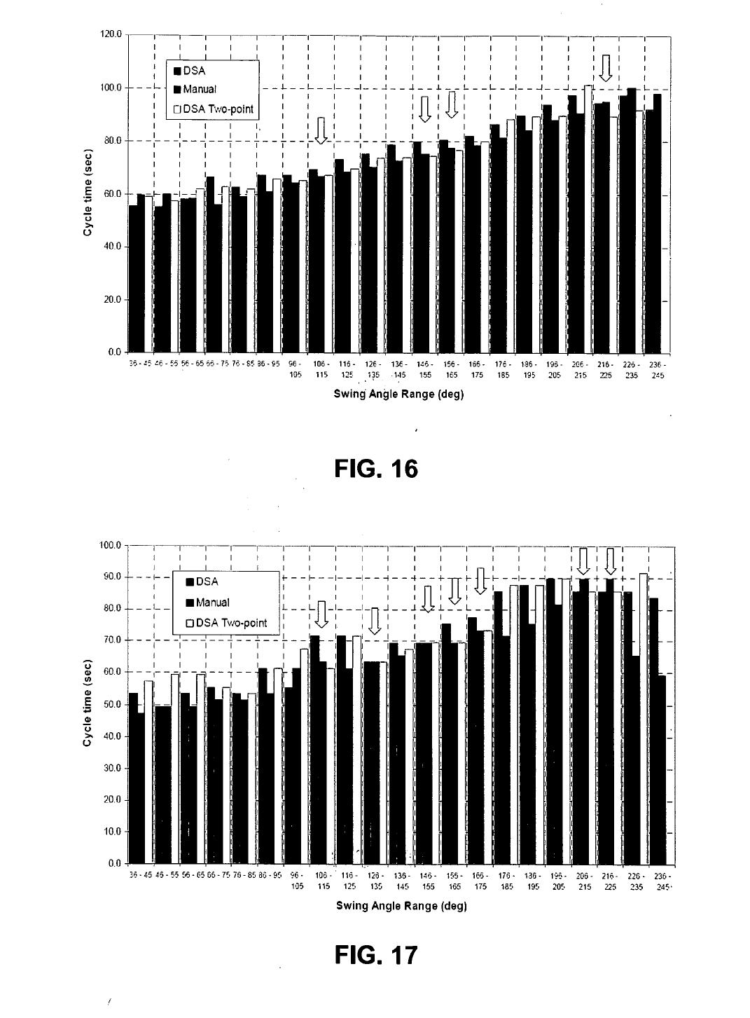

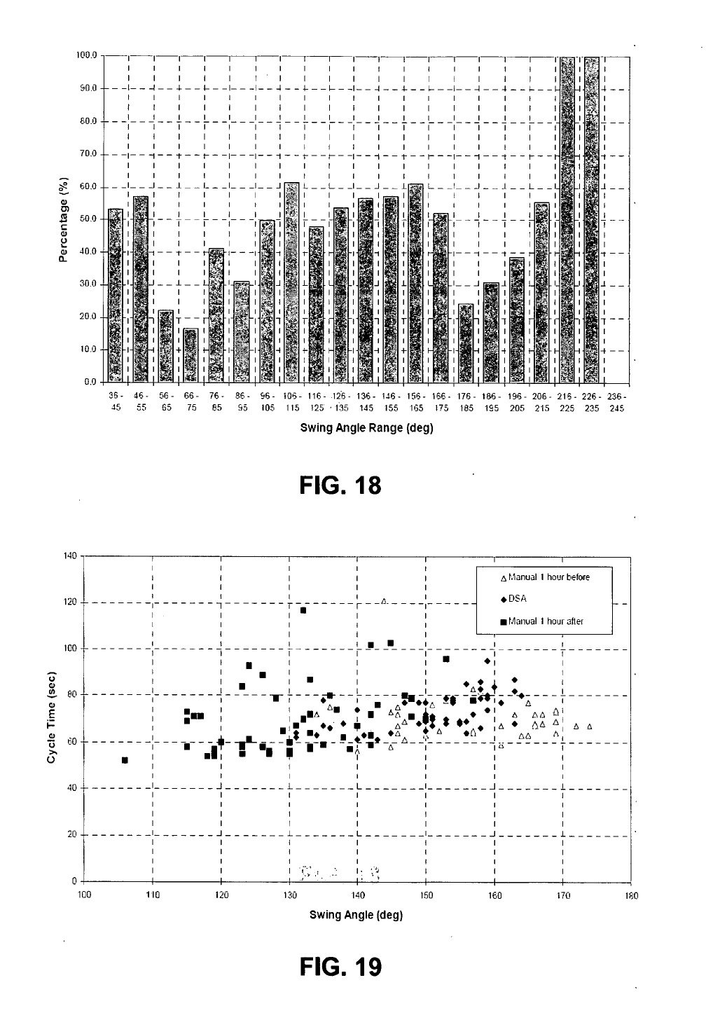

It was observed that during this trial, that the system demonstrated best performance when the paths had just two-points. Using just the two-point cycles, the statistics of FIGS. 12 and 13 can be recomputed, as shown in FIGS. 16 and 17. Arrows indicate instances when the DSA system is equal to (or outperforms), the manual operation of the dragline. FIG. 16 is a histogram (similar to FIG. 12), comparing the two-point DSA mean cycle times for binned swing angles. FIG. 17 is a histogram (similar to FIG. 13), comparing the mean and peak (mode) two-point statistics for binned swing angles.

FIGS. 16 and 17 shows that the DSA cycle times are much closer too, if not better than the operation times, especially in the swing angle range 96°-175°. Using the DSA two-point cycles, the percentage of two-point cycles which are better or equal to the mean manual cycle time are determined for the binned swing angles.

FIG. 28 shows a histogram of percentage of two-point DSA cycles better than mean manual operator cycle times. This histogram indicates that for a number of swing angle bins the DSA system out performs the manual operator as indicated by over 50% of cycles quicker than the mean overall operator cycle time for that bin. These results indicate that when the DSA system is not penalised by the requirement of via-points to avoid benches and spoil piles, as eliminated by the two-point cycles, the DSA system is very competitive to manual operation of the dragline.

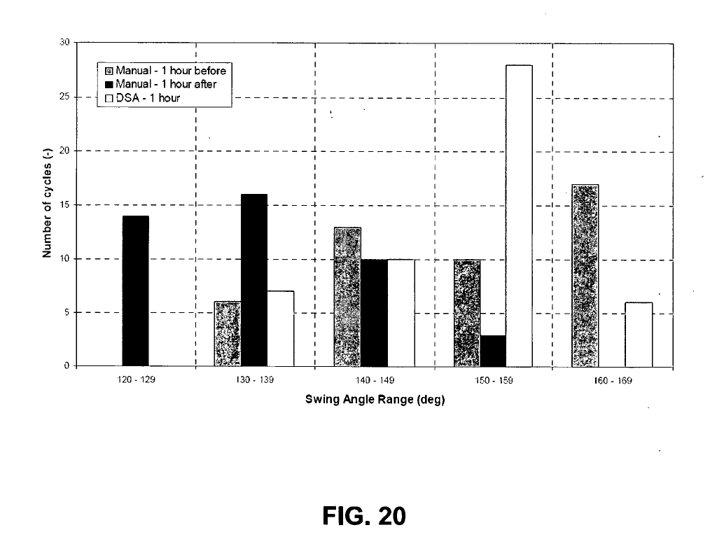

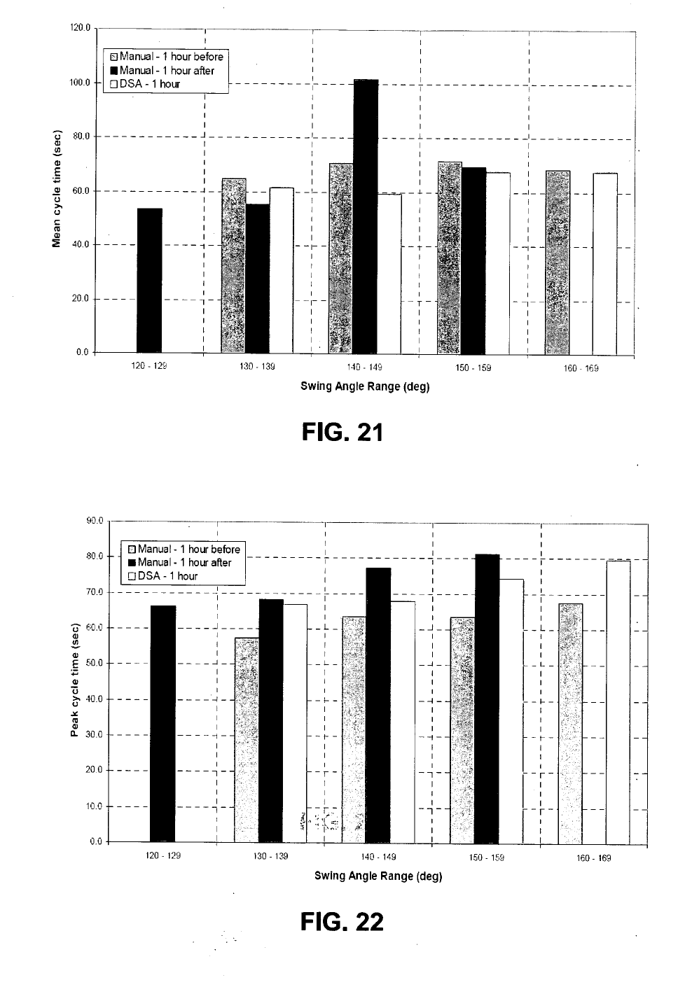

As a further study, analysis of adjacent manual/assist cycles was performed to illustrate the potential of the DSA system. A representative sample of cycles were segregated and analysed. These correspond to known same digging conditions for both the manual and DSA system. In this sample, one hour of manual cycles were extracted, then an hour of DSA cycles, followed by another hour of manual cycles for comparison. FIG. 19 is a scatter plot of the distribution of cycle times with swing angles for adjacent manual/assist cycles. FIG. 20 is a histogram of the binned swing angles for adjacent manual/assist cycles. FIG. 21 is a histogram (similar to FIG. 12), comparing the mean cycle times of binned swing angles for adjacent manual/assist cycles. FIG. 22 is a histogram (similar to FIG. 13), comparing the mean cycle times of binned swing angles for adjacent manual/assist cycles.

FIG. 19 shows that the distributions are relatively compact with some outliers, each with approximately 50 cycles. These were binned into 10 degree increments as per previous analysis. FIG. 20 shows a histogram of the binned swing angles. This figure indicates that most cycles occur in the range 130°-159°.

FIGS. 21 and 22 show the mean and peak cycles times is performed on this date set. The mean DSA times are in general better than the operator times, and the peak times show that the system is working in the mid-range of the two operator shifts.

In these examples, these results shows that the DSA system (when tuned correctly), is not hindered by excessive conservatism in hoisting, the system is as good, if not better than manual operation of the dragline. This illustrates the potential of the system.

In summary, the DSA method and system can:
match or exceed operator performance in some, but not all, modes of operation;
provide a highly reliable outcome.
allow an operator interface that is relatively intuitive and accepted by operators.

By way of example only, the method and system can be compared to an operator with a skill level corresponding to about 6 months training. The system and method however perform consistently higher at particular skills, such as bucket disengage, dumping and recovery.

Incorporating terrain mapping can reduce the conservatism required in the path planning mechanism of the DSA.

In relation to excavation equipment, and draglines in particular, the following can be implemented:
Active controls, when applied to a dragline provides significant safety benefits;
Path planning can improve efficiencies;
Path-planning using Digital Terrain Maps would provide increased versatility;
Bucket recovery can include anti-stall; and
Calibrated Digital Terrain Maps can be used for navigating around obstacles.

It will be appreciated that the illustrated embodiments provide a control method and system for assisting operator control of machinery to improve efficiency and productivity in the open-cut mining domain.

Although the invention has been described with reference to specific examples, it will be appreciated by those skilled in the art that the invention may be embodied in many other forms.

1. A method for controlling an excavation device in one or more of the following phases of operation: digging, moving to spoil, dumping, recovery and return, the method including the steps of:
(a) providing a finite state machine having state variables reflecting the different phases of operation, including, digging, dumping, moving to dump location, return to dig, and bucket recover;
(b) determining current machine state depending on the position of the device; and
(c) modifying the operational behaviour of a one or more subordinate controllers in response to the current state.

2. A method according to claim 1, wherein the excavation device is a dragline or electric shovel.

3. A method according to claim 1, wherein determining a current machine state includes determining a dynamic and kinematic state of the device, wherein the dynamic and kinematic state are obtained from other electronic systems on the device.

4. A method according to claim 2, further comprising the step of obtaining additional sensor measures for tracking dragline ropes.

5. A method according to any previous claim, further comprising the step of: obtaining additional sensor measures; wherein the measures are used to infer one or more of the set comprising:
(i) the side-to-side angle of the hoist ropes; and
(2) the angle of the hoist ropes from vertical within the boom plane; and
(3) the total force acting on the suspended load;
(4) the hoist rope force;
(5) the drag rope force;
(6) bucket carry angle;

6. A method according to any previous claim, further comprising the step of: obtaining additional measures from a kinematic and dynamic model of the dragline, its drive system and the rigging system.

7. A method as claimed in any previous claim, further comprising the step of: controlling the drag, hoist and slew drives by incorporating a feed-forward component from one or more of set comprising:
(i) the planned path velocity;
(ii) the planned acceleration;
(iii) the disturbance force due to the interaction forces of the hoist and drag ropes;
(iv) the disturbance force due to the weight of the bucket; and
(v) the disturbance force due to the tub slope, and bucket carry angle.

8. A method as claimed in any previous claim according to any one of claims 3 to 8, wherein operation of the subordinate controller is modified to provide one or more operations selected from the set comprising:
(i) recovering the bucket;
(ii) disengaging the bucket from the ground at the end of bucket filling;
(iii) managing the hoist rope during digging;
(iv) maintaining carry angle during the path to dump;
(v) maintaining drag rope force within a designated bound;
(vi) maintaining swing angle within designated bounds;
(vii) controlling the bucket swing angle to direct the spoil to the desired location;
(viii) identifying the completion of bucket dumping;
(ix) placing the bucket on the ground prior to digging;
(x) dynamically varying the motor field current during operation of the device; and
(xi) eliminating stall.

9. A method as claimed in any previous claim, wherein active controls are used for modifying the operational behaviour of one or more subordinate controllers in response to the current state.

10. A method according to any one of the preceding claims, further comprising the step of obtaining a digital terrain map for evaluating the landscape environment about the operational location of the dragline.

11. A method according to any one of the preceding claims, comprising the step of planning a control path though space for an element of the excavation device.

12. A method according to claim 11, further comprising the step of providing a command signal indicative of moving the element of the excavation device substantially along the control path.

13. A method according to claim 12, wherein the element of the excavation device is an excavation bucket, and wherein the control path is defined in terms of an initial pose, final pose and zero or more intermediate via points.

14. A method for controlling an excavation device, substantially as herein described with reference to any one of the embodiments of the invention illustrated in the accompanying drawings and/or examples.

15. A computer-readable carrier medium carrying a set of instructions that when executed by one or more processors cause the one or more processors to carry out a method of according to any one of the preceding claims.

16. A system comprising one or more processors, the processors adapted to perform a method according to any one claims 1 to 14.

17. A system for controlling an excavation device in one or more of the following phases of operation: digging, moving to spoil, dumping, recovery and return, the system including:
a finite state machine having state variables reflecting the different phases of operation, including, digging, dumping, moving to dump location, return to dig, and bucket recover;
a current machine state variable of the finite state machine determined depending on the position of the excavation device; and
modification means for modifying the operational behaviour of one or more subordinate controllers in response to the current state.

18. A system according claim 17, wherein the excavation device is a dragline or electric shovel.

19. A system according to claim 18, further comprising a sensor for tracking dragline rope position, said sensors inputting the position to the finite state machine for setting the current machine state variable.

20. A system according claim 18 or claim 19, wherein the device is controlled to provide one or more operations selected from the set comprising:
(i) recovering the bucket;
(ii) disengaging the bucket from the ground at the end of bucket filling;
(iii) managing the hoist rope during digging;
(iv) maintaining carry angle during the path to dump;
(v) maintaining drag rope force within a designated bound;
(vi) maintaining swing angle within designated bounds;
(vii) controlling the bucket swing angle to direct the spoil to the desired location;
(viii) identifying the completion of bucket dumping;
(ix) placing the bucket on the ground prior to digging;
(x) dynamically varying the motor field current during operation of the device; and
(xi) eliminating stall.

22. A system according any one of claims 19 to 21, wherein the dragline controls are active controls.

23. A system according claim 22, wherein the active controls are implemented using electric motors through an electric clutch, such that when the dragline is controlled the manual control inputs are engaged.

24. A system according claim 23, wherein the active controls interpret restriction in their motion as an override request, which deactivates the automatic control of the dragline and reverts back to manual control.

25. A system according any one of claims 19 to 24, wherein training is manually provided.

26. A system according claim 25, wherein training includes identifying the location of the dig point and the location of the dump point.

27. A system according claim 26, wherein training further includes identifying the location of intermediate via points.

28. A system according to any one of claims 19 to 27, wherein the system is adapted to obtain a digital terrain map for evaluating the landscape environment about the operational location of the device.

29. A system for controlling an excavation device, substantially as herein described with reference to any one of the embodiments of the invention illustrated in the accompanying drawings and/or examples.

30. A method for controlling an excavation device in one or more of the following phases of operation: digging, moving to spoil, dumping, recovery and return.
